(19) United States
(12) Patent Application Publication
(10) Pub. No.: US 2025/0347312 A1
(43) Pub. Date: Nov. 13, 2025

(54) UNIVERSAL SUCTION MOUNT BASE

(71) Applicant: Joshua STEBBINS, Savannah, GA (US)

(72) Inventor: Joshua STEBBINS, Savannah, GA (US)

(21) Appl. No.: 19/094,576

(22) Filed: Mar. 28, 2025

Related U.S. Application Data
(60) Provisional application No. 63/644,677, filed on May 9, 2024.

(51) Int. Cl. F16B 47/00; F16M 13/02

(52) U.S. Cl. CPC F16B 47/00; F16M 13/02; F16M 2200/08

(57) ABSTRACT

A detachable apparatus for mounting onto a surface and supporting a device includes a backrest including a forward facing surface and a rearward facing surface. A nano-suction cup surface is coupled to the rearward facing surface of the backrest. The nano-suction cup surface faces rearward from the backrest and is configured to self-adhere to the support surface. In addition, a shelf projects forward from the forward facing surface of the backrest and is configured to support the device.

### CROSS-REFERENCE TO RELATED APPLICATIONS

This application claims benefit under 35 U.S.C. § 119(e) of U.S. Provisional Application having Ser. No. 63,644,677 filed May 9, 2024, which is hereby incorporated by reference herein in its entirety.

### FIELD

The subject disclosure relates to mounting systems, and more particularly, to a universal suction mount base.

### BACKGROUND

In the field of mounting objects to support surfaces the mounting mechanism takes many forms. Some mechanisms are fixed to the supporting surface. For example, nails, screws or glue permanently attach an object to a wall. Some mechanisms use temporary systems that allow the object to be removed from the wall at-will. For example, hooks, hook and loop systems, and magnets are examples of temporary mounting elements.

Fixed mounting systems generally cause permanent damage to the mounting surface. The permanent device usually requires compromising the substrate of the surface being mounted onto. For example, nails and screws must physically break through the mounting surface to gain a foothold. Glue may not immediately damage a surface but when trying to remove the object glued to the mounting surface, the glue will usually pull some of the mounting surface with it when detaching the object.

Temporary mounting systems can be more convenient for attaching and detaching an object from a surface. However, temporary mounting systems can be limited in their capacity to hold an object. The weight of the object being held can commonly overcome the bond strength of temporary mounting systems to the mounting surface.

### SUMMARY

In one embodiment of the disclosure, a detachable apparatus for mounting onto a surface and supporting a device is disclosed. The detachable apparatus includes a backrest including a forward facing surface and a rearward facing surface. A nano-suction cup surface is coupled to the rearward facing surface of the backrest. The nano-suction cup surface faces rearward from the backrest and is configured to self-adhere to the support surface. A holder projects forward from the forward facing surface of the backrest, configured to support the device.

In another embodiment, a detachable apparatus for mounting onto a surface and supporting a device is disclosed. The detachable apparatus includes a support element including a front side and a rear side. The detachable back plate is configured to couple to the rear side of the support element. The back plate includes a rear surface. A nano-suction pad is coupled to the rear surface of the back plate and is configured to removably adhere to the support surface. A retention element is coupled to the support element and configured to support the device.

In yet another embodiment, a detachable apparatus for mounting onto a surface and supporting a device is disclosed. The detachable apparatus includes a wall including a front side and a rear side. A detachable back plate is configured to couple to the rear side of the wall. The back plate includes a rear surface. A nano-suction pad is coupled to the rear surface of the back plate and is configured to removably adhere to the support surface. A cradle is coupled to the front side of the wall and is configured to support the device. It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a perspective view of a universal suction cup mounting apparatus, according to an example embodiment.

FIG. 2 is a partial rear view of a back plate of the apparatus of FIG. 1 with an enlarged view of a suction cup pad, according to an example embodiment.

FIG. 3 is a side view of the apparatus of FIG. 1.

FIG. 4 is a perspective side view of the apparatus of FIG. 1.

FIG. 5 is a perspective bottom view of the apparatus of FIG. 1.

FIG. 6 is an exploded rear, side perspective view of the apparatus of FIG. 1.

FIG. 7 is a rear, side perspective view of the apparatus of FIG. 6 without the backplate of

FIG. 6 installed.

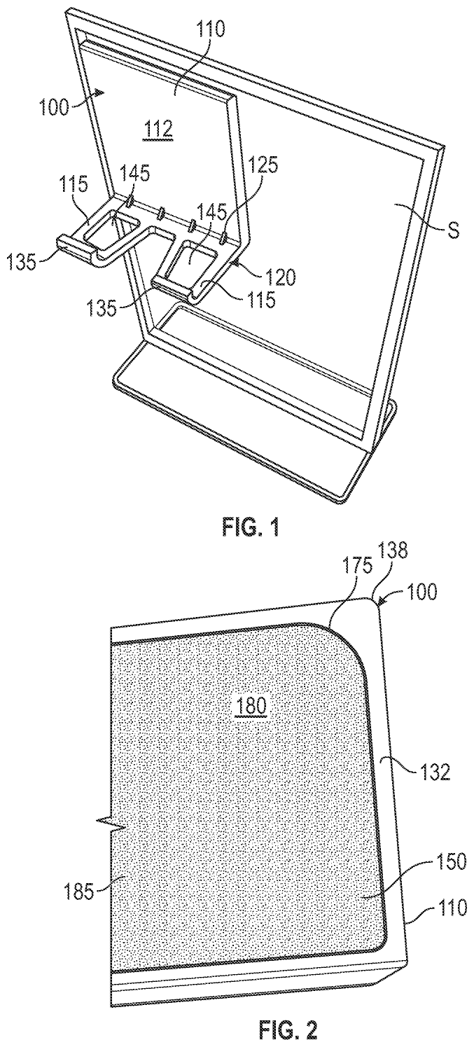

FIG. 8 is a bottom view of the apparatus of FIG. 1.

FIG. 9 is a perspective front view of the back plate of FIG. 6.

FIG. 10 is a front view of the back plate of FIG. 6.

FIG. 11 is a perspective front, bottom edge view of the back plate of FIG. 6.

FIG. 12 is a rear view of the back plate of FIG. 6 with a suction cup pad.

FIG. 13 is a perspective side view of a suction cup apparatus, according to another embodiment.

FIG. 14 is a front perspective view of the apparatus of FIG. 13.

FIG. 15 is a top perspective view of the apparatus of FIG. 13.

FIG. 16 is a front perspective view of a suction cup apparatus, according to another embodiment.

FIG. 17 is a side perspective view of the apparatus of FIG. 16.

FIG. 18 is a front side view of a back plate according to another embodiment.

FIG. 19 is a perspective view of the back plate of FIG. 18.

FIG. 20 is a front perspective view of a suction cup apparatus, according to another embodiment.

FIG. 21 is a rear, side perspective view of the apparatus of FIG. 20.

FIG. 22 is a rear view of the apparatus of FIG. 20.

FIG. 23 is a top view of the apparatus of FIG. 20.

FIG. 24 is a bottom view of the apparatus of FIG. 20.

### DETAILED DESCRIPTION OF PREFERRED EMBODIMENTS

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

### Overview

In general, and referring to the Figures, embodiments of the subject technology include a mounting system that includes a nano-suction pad coupled to a supporting mechanism of a container or holder. The number of surfaces the nano-suction pad may adhere to varies widely. Aside from walls and glass surfaces, other pre-existing devices or free-standing devices may have surfaces onto which the nano-suction pad may be affixed which adds functionality to the pre-existing device. For example, tripods for cameras/smartphones, stands, chairs, etc. which have a primary function may also serve as a holder when the mounting system is attached. As will be appreciated, the number of applications that can benefit from the nano-suction pad/support mechanism combination vary widely. Some examples of applications include electronic devices such as smart phones, tablets, and portable speakers. Non-electronic applications of the subject technology include for example, a holder of loose articles such as keys, a holder for toiletries, a food/snack container, a bird feeder, etc. As can be seen, a wide variety of applications become available that will benefit from the ability of the nano-suction pad to adhere to different surfaces while supporting a container or holder.

### Embodiments

Referring now to FIG. 1, an apparatus 100 is shown that is configured to hold another device, for example, a smart phone, electronic device, and objects in general, either vertically or horizontally, onto a support surface S. The apparatus 100 includes a supporting element 110 and a retention element 120 for supporting a device. The supporting element 110 may be a wall or backrest. While the supporting element 110 is shown by example to be generally rectangular, other shapes are contemplated within the scope of embodiments disclosed herein. The retention system 120 may be a holder, shelf system, cradle, arm or wide hook and is generally configured to hold a device while the supporting element is mounted to the support surface S.

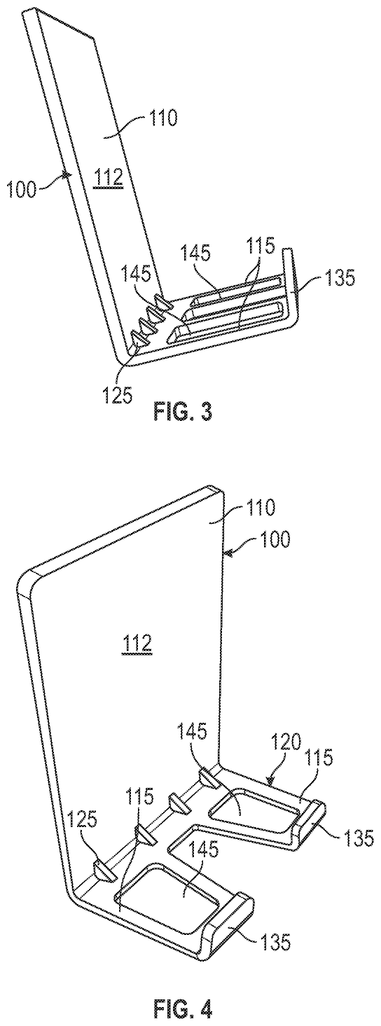

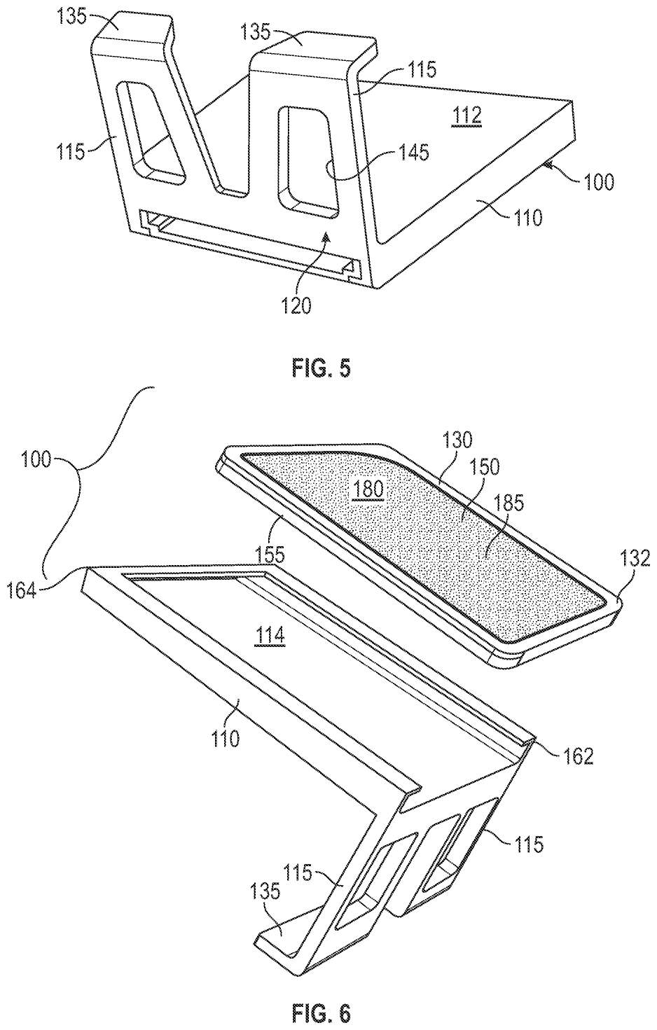

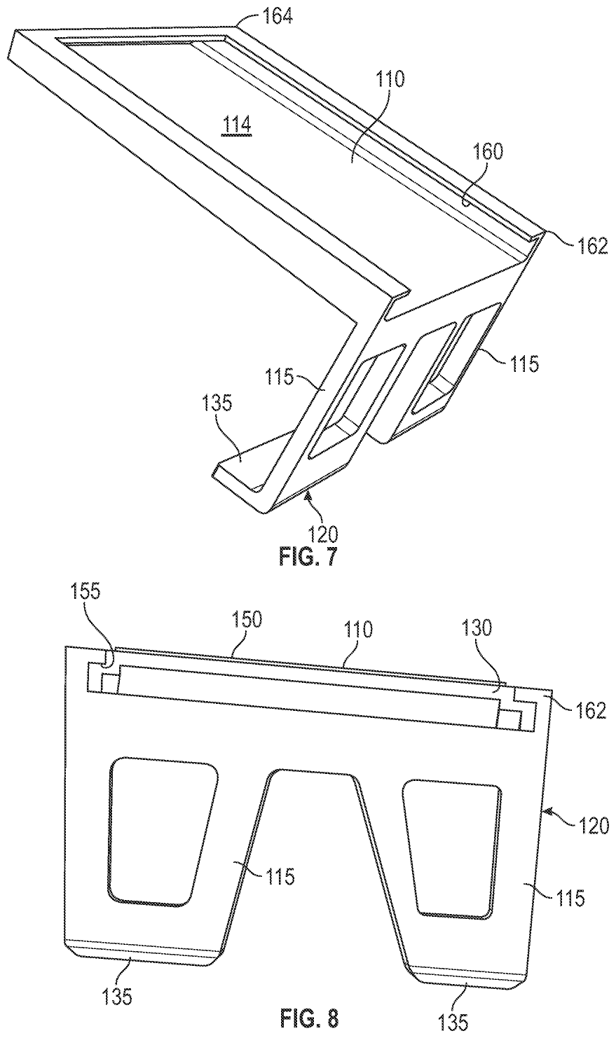

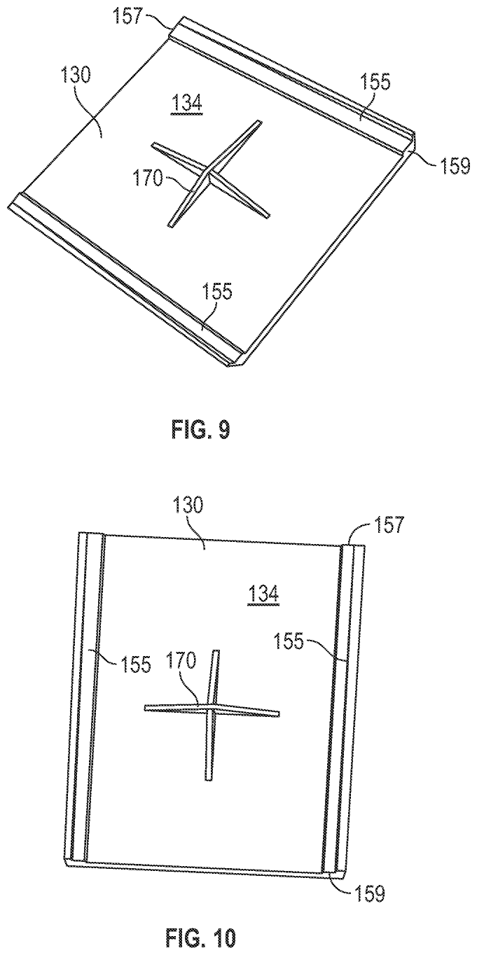

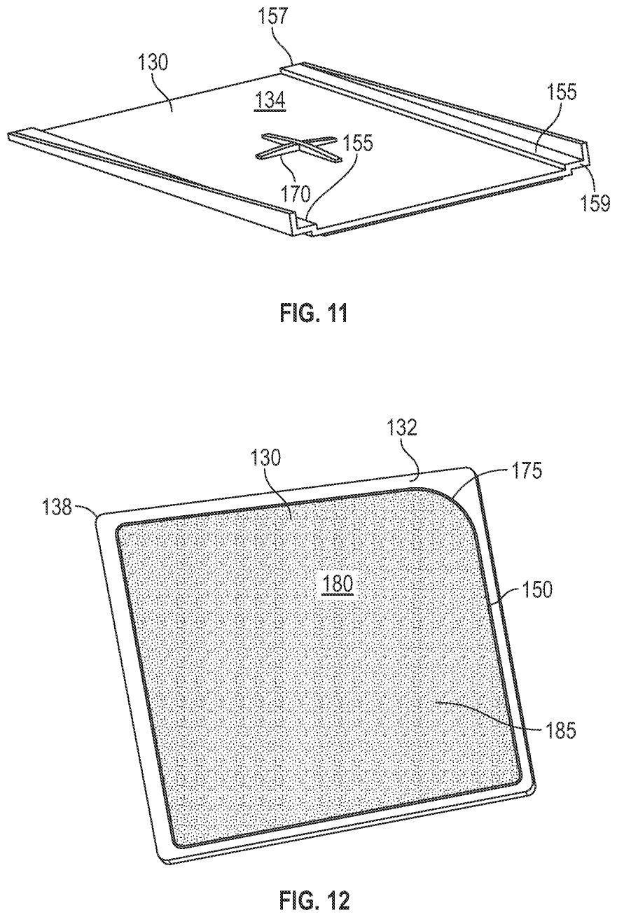

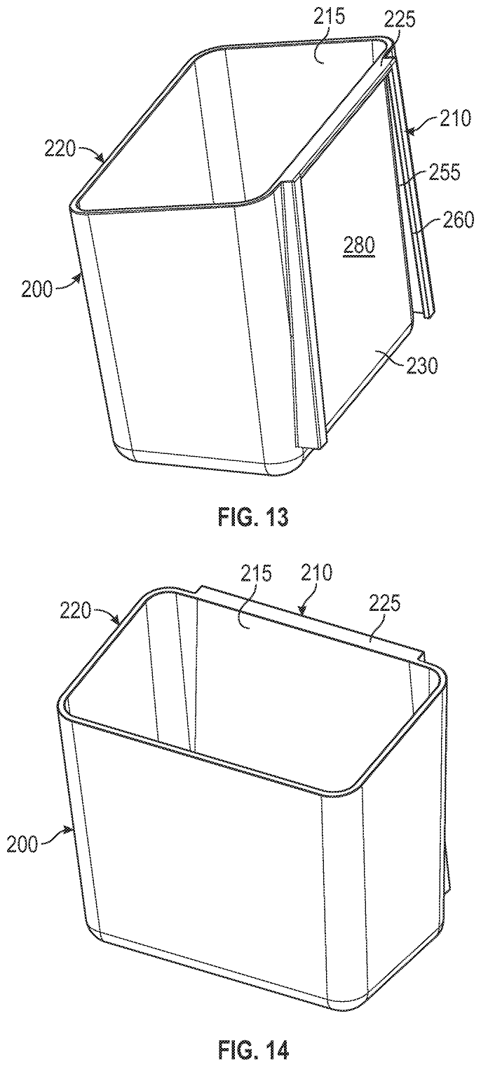

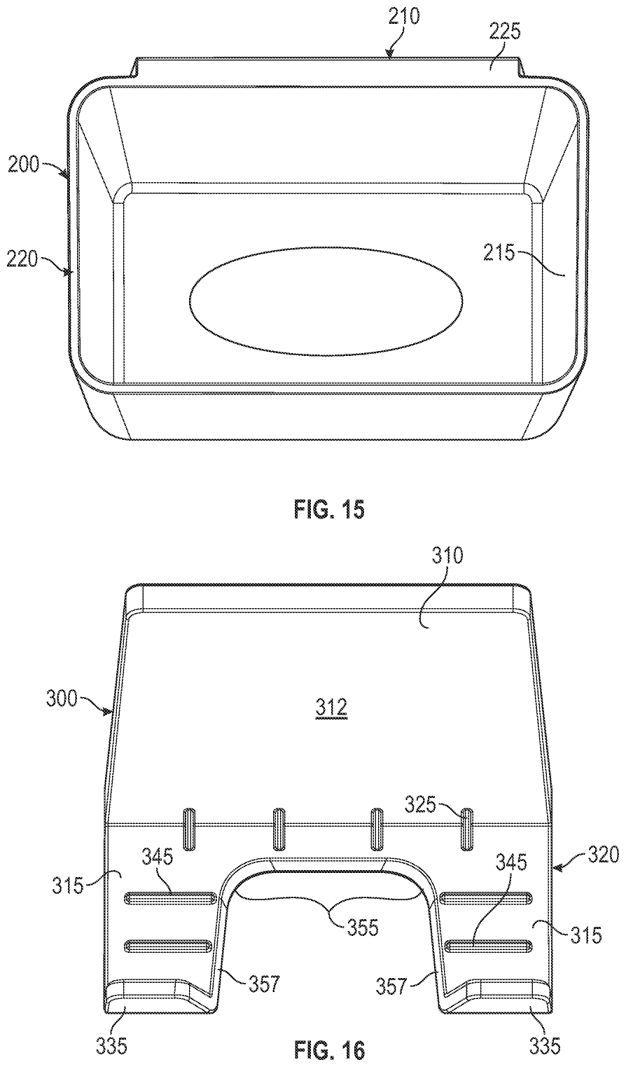

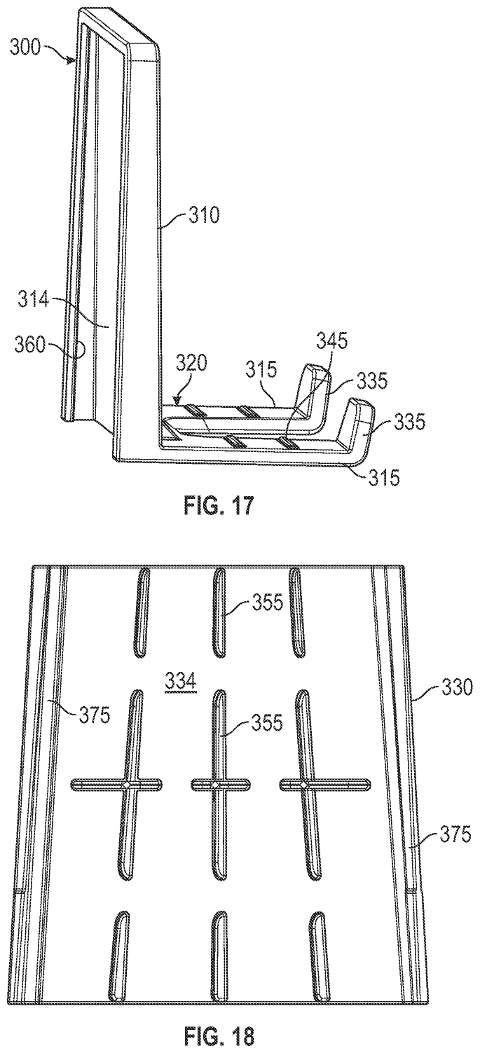

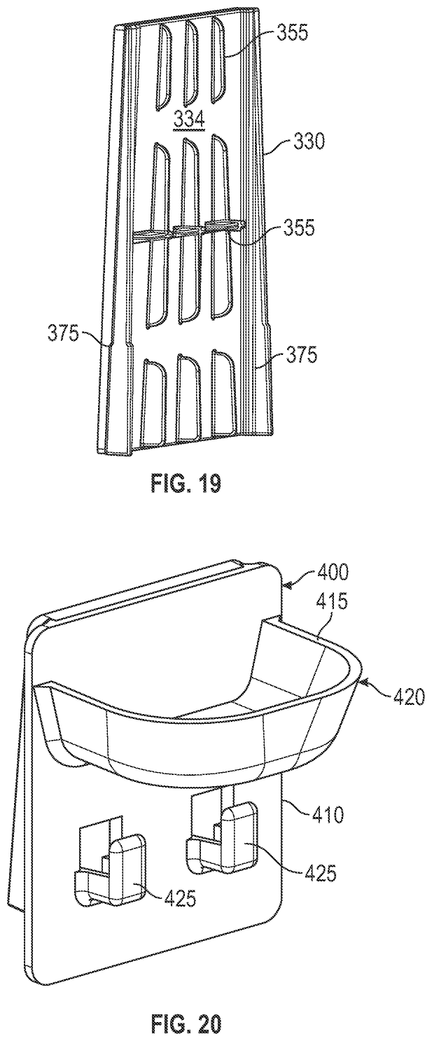

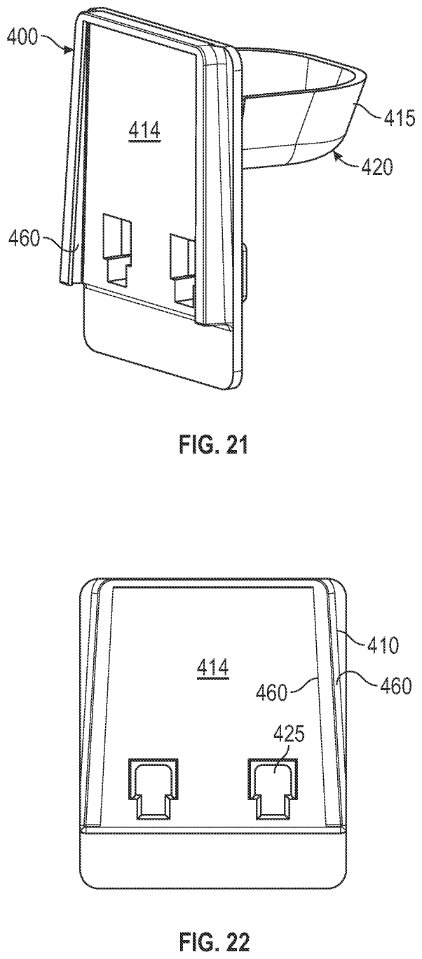

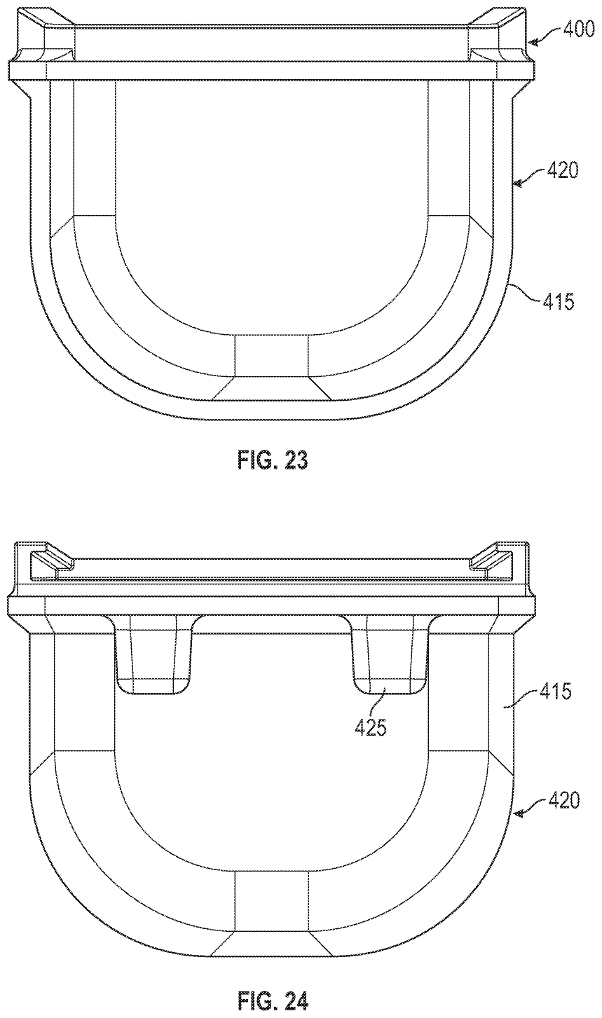

As shown in FIGS. 1-8, the supporting element 110 may include a front side or forward facing surface 112. “Forward” (or “front facing”) as used in the embodiment illustrated, refers to the direction facing out and away from the supporting surface S onto which the apparatus 100 is adhered to. Accordingly, “rearward” (or “rear facing”) as used herein refers to the direction opposite the forward direction meaning toward the support surface S. The supporting element 110 may include a rear side or rearward facing surface 114 on the side of the supporting element 110 wall opposite the front side 112 (see FIGS. 6 and 7).

As shown in FIGS. 1 and 3-8, the retention element 120 may include one or more arms 115 projecting outward (forward) from the supporting element 110. The arm(s) 115 may project orthogonally from the backrest or may be attached at a slight acute angle to bias the device toward the front side 112 of the supporting element 110. While the retention element 120 is shown attached to a lower extremity of the supporting element 110, other embodiments may position the retention element 120 higher up the front side 112. Some embodiments may include gussets 125 reinforcing the connection between the supporting element 110 and the retention element 120. The distal end of the arm(s) 115 may include a retaining wall 135 to prevent the device being supported from falling off the apparatus 100. Some embodiments may have the arms 115 spaced from one another. In some embodiments, the arms 115 may include an aperture 145. The space between arms 115 and/or the apertures 145 allow sound to travel unencumbered from a speaker or to a microphone of the device being supported. Access by a speaker or microphone to either the space or apertures 145 may depend on how to device is laid on the arms 115 (for example, either horizontally or vertically depending on the device).

Referring now to FIGS. 2, 6, and 12, in an exemplary embodiment, the apparatus 100 includes a suction pad 150 on a back plate 130 coupled to the rear side 114 of the supporting element 110. In some embodiments, the back plate 130 may be a fixed or permanent surface of the supporting element 110 in lieu of the rear side 114. The suction pad 150 may comprise foam that includes a nano-suction cup surface 180 comprising thousands (to millions) of nano-sized suction cups 185. The nano-suction cup surface 180 is located on a rear side 132 of the back plate 130 and is disposed for removable attachment to flat surfaces (for example, glass, plastic, stone, etc.) via suction to the support surface S (for example, as shown in FIG. 1). The foam nano-suction cup surface 180 may include nanometer size crevices that behave as suction cups 185 which can be seen when the foam is pressed. The crevices form vacuums when the nano-suction cup surface 180 is pressed against a smooth surface, creating suction. As will be appreciated, the size of the suction cups 185 creates an improved vacuum seal because the density footprint of the elements create suction that is larger and more reinforced with thousands of “suction cups” rather relying on just one large cup or a few suction cups. Hence, the weight distribution of the device being supported is distributed more evenly and efficiently on the support surface S. The apparatus 100 may be removed with user force overcoming the suction power of the nano-suction cup surface 180. The apparatus 100 may then be re-adhered to the support surface S or moved to a different support surface S as needed.

Referring now to FIGS. 6 and 8-11, the back plate 130 is preferably detachable and coupled to the rear side 114 of the supporting element 110. The back plate 130 may include a front side or forward facing side 134 that faces the rear side 114 when coupled to the back of the supporting element 110. The back plate 130 may include a rear side or rearward facing side 132 that faces toward and is disposed to couple with the support surface S of the support structure. By making the back plate 130 removable, the back plate 130 may be coupled to a variety of supporting structures (for example, to different instances of the supporting element 110 and the retention element 120).

In some embodiments, the apparatus 100 may be a kit. The kit may comprise the supporting element 110 separately from the back plate 130. The supporting structures, such as a shelf system for holding a smartphone, will preferably be configured with a connection mechanism for removably connecting to the back plate 130. The kit preferably comprises the detachable back plate 130 and a variety of supporting structures that can be removably coupled to the back plate. For example, the supporting structure may comprise a supporting shelf, a receptable, a cup holder, a magnet, a pen holder, a microphone holder, a hook with a support back, a tray, a cup, a box, a curtain hanger, a birdfeeder, a fishtank food holder and a variety of holders and structures capable of providing storage or holding objects. For sake of illustration, the various supporting structures are not shown. However, the stand with support surface S shown in FIG. 1 represents one such example of a supporting structure, which can be interchanged with any of the numerous examples, as well as others, in kit embodiments. In use as a kit, separate instances of the back plate 130 may be adhered to different supporting structures. A supporting element 110 and retention element 120 may be temporarily connected to any one of the back plate 130 instances and moved around to different back plate 130 instances as needed. As may be appreciated, this provides a user with flexibility in selecting sites they commonly use for temporarily holding a device while moving about throughout their day. As an illustrative example, a user may attach a first back plate 130 to a stand next to their bed. As the user wakes up, the device and supporting element 110/retention element 120 combination may be detached from the back plate 130 on the stand and re-attached to a mirror in the user's bathroom so that the device can be in use or generally available while the user goes through their morning ritual. When the user moves to another room, the user may detach the supporting element 110/retention element 120 from the back plate 130 on the bathroom mirror and may re-attach the supporting element 110/retention element 120 to a third pre-mounted back plate 130 elsewhere in the domicile, the user's car, or at a place of work. As may be appreciated, the back plates 130 may benefit from the kit embodiment by maintaining a strong adherence to their respective mounting sites without the danger of losing adhesive power that may occur over time when removed and re-attached to different sites. The user may benefit from having to buy one (or just a few) supporting element 110/retention element 120 parts that can be used with different back plates 130 as needed.

Referring to FIGS. 6-11, some embodiments of the apparatus 100 include a removable connection mechanism for coupling the back plate 130 to the supporting element 110 such as a tongue and groove system. As shown in an illustrative embodiment, the rear side 114 of the supporting element may include slotted rails for the grooves 160 on the side edges.

In some embodiments, the walls defining the rails may include a tapering surface so that the opening of the grooves 160 tapers down from the bottom edge 162 of the supporting element 110 toward the top edge 164 where the groove 160 is its thinnest. The back plate 130 may include corresponding tapered tongues 155 whose profiles taper thinner from the top edge 157 of the back plate to the bottom edge 159 of the back plate and may be indexed to match the slope of taper of the grooves 160.

Some embodiments may include a spacer 170 where the central area of the front side 134 of the back plate 130 has a feature with a thickness that protrudes above the surface of front side 134. The spacer 170 may provide ease in removing the back plate 130 from the rear side 114 of the supporting element 110. As seen from the bottom view of the apparatus (FIG. 10), the spacer 170 helps create a gap between the back plate 130 and the rear side 114 of supporting element 110. In some embodiments, the spacer 170 includes crossing ridges that taper down from the center or intersection of the ridges. When the back plate 130 is inserted into the supporting element 110, the spacer 170 helps provide reinforced contact when a user mounts the apparatus 100 to a support surface S and presses the supporting element 110 against the back plate 130. The spacer 170 helps add force to the back plate 130 while keeping the body of the supporting element 110 from over-bowing, causing the suction pad 150 to contact the flat surface more evenly and more securely.

In operation, the thinner profile ends of the tongues 155 are slid into the bottom edge 162 on the rear of the supporting element 110 and inward until the top edge 157 of the back plate 130 reaches proximate the top edge 164 of the supporting element 110. In some embodiments, the thickest end of the tongues 155 may be configured to lock in the back plate 130 into the grooves 160 of the supporting element by press fit.

In a preferred embodiment, the detachable back plate 130 with the preferred suction pad 150 may be removably coupled to a variety of devices that might otherwise use a conventional suction cap. For example, the preferred detachable back plate 130 may be removably coupled to a portable audio speaker, thereby enabling the portable audio speaker to be attached to a wall, such as a shower wall. By including a removable connection mechanism, such as the tongue and groove system (155/160) discussed above, in such devices, the back plate 130 can then be used to “stick” a variety of devices onto flat surfaces. In a preferred embodiment, the supporting element 110 with the removable connection mechanism may be formed on to a variety of devices and products that would otherwise use a conventional suction cup. The supporting element 110 may be integrally formed with, or removably attached to, such devices.

FIGS. 2 and 12 illustrate an embodiment that includes a rounded corner 138 of the rear side 132 of the back plate 130. A rounded corner 175 of the suction pad 150 may be adjacent to and spaced from the rounded corner 138. As will be appreciated, the area of the rear side 132 on the back plate 130 spaced from the rounded corner 175 provides extra clearance in that corner of the back plate 130 so that when a user seeks a foothold to detach the apparatus 100 from the support surface S, the rounded corner 175 provides extra area for a fingertip to access the underside (rear side 132) of the back plate 130 to lift the suction pad 150 away from the mounting support surface S.

In the embodiments that follow, while no specific reference is made to the nano-suction cup surface 180 or nano-sized suction cups 185, it should be understood that each embodiment is contemplated to include the nano-suction cup surface 180 and/or nano-sized suction cups 185 on a rear facing surface of the supporting element embodiments described below.

Referring now to FIGS. 13-15, apparatus 200 is shown according to an embodiment. The apparatus 200 is similar to the apparatus 100 except that the retention element 220 is a basket. The supporting element 210 is similar to the supporting element 110. The supporting element 210 includes a back plate 230 with a nano suction cup surface 280. The back plate 230 may be detachable via a tongue 255 and groove 260 system similar to the tongue 155 and groove 160 of apparatus 100. The top rear edge of the supporting element 210 may include a lip 225 configured to receive the top ends of the tongues 255 of the back plate 230. The basket may be an open-faced container that has a height that extends beyond the height of the back plate 230.

Referring now to FIGS. 16 and 17, an apparatus 300 is shown according to an embodiment. The apparatus 300 is similar to the apparatus 100 in that the apparatus 300 may be configured to receive a detachable back plate 130 (FIG. 6) within a groove system 360 on rear surface 314 of supporting element 310. The retention element 320 differs from retention element 120. The retention element 320 includes a pair of solid arms 315 projecting forward from the interface with supporting element 310. The arms 315 may be spaced wider than the arms 115. A concave wall 355 positioned toward the rear edge of the retention element 320 (near the interface with supporting element 310) may include a flat central portion. The spacing between the side walls 357 of the concave wall 355 may be configured to allow speakers and microphones of electronic devices to be unobstructed. In addition, the increased spacing provides better support and stability for larger devices such as tablets or non-electronic device (such as items for display). Embodiments may include one or more ridges 345 on the top surface of the arms 315. The ridges 345 may be configured to increase the stability of items placed within the arms 315 by preventing movement, for example sliding, along the top surface of the arms 315. Embodiments may include retaining walls 335 at the end of the arms 315 to prevent items being held from falling off the retention element 320. Gussets 325 may reinforce the interface between the supporting element 310 and retention element 320.

FIGS. 18 and 19 shows a back plate 330 consistent with embodiments. The back plate 330 may be similar to the back plate 130 except that the front surface 334 may include a plurality of spacers 355 raised above the surface 334. The back plate 330 may be used with any of the foregoing embodiments of the retention elements 110, 210, or 310. A tongue system 375 may be positioned on the outer side edges to mate with groove systems 160, 260, or 360 described above. The spacers 355 may comprise vertical and/or horizontal members distributed throughout the forward facing surface 334. Some embodiments position the spacers 355 from the top edge to the bottom edge of the back plate 330. As shown, the central instances of spacers 355 include both horizontal and vertical members in cross-shaped or star-shaped protrusions. The upper and lower instances of the spacers 355 may be all vertical protrusions. However, some embodiments may use just horizontal protrusions. As will be appreciated, the distribution of spacers 355 around the forward surface 334 distributes pressure exerted onto the back plate 330 when a user presses the apparatus 300 onto a mounting surface S. When pressure is distributed more evenly because of the spacers 355, the nano-sized suction cups 185 will have better adherence to the underlying surface.

Referring now to FIGS. 20-24, an apparatus 400 is shown according to an embodiment. The apparatus 400 includes a supporting element 410 that is similar to the supporting element 110 and may be detachable from a retention element 420 similar to attachment configuration of the supporting element 110 to the retention element 120. For example, FIGS. 21 and 22 show a rearward facing surface 414 on the rear of the supporting element 410 that includes a groove system 460 configured to receive a tongue system of a back plate (which may be any of embodiments 130, 230, or 330 disclosed above). The retention element 420 may include a tray 415 positioned proximate a top edge of the supporting element 410. The tray 415 may be a shallow, open-faced, rounded container. Some embodiments may include one or more hooks 425 on the retention element 420. The hooks 425 may be positioned below the tray 415 to provide ample space for items to hang from without interference from overhead elements. In some embodiments, the hooks 425 may be molded protrusions that project forward from the supporting element 410. In some embodiments, the hooks 425 may be aligned next to one another as a cooperating pair so that longer items may be placed onto both hooks 425 simultaneously. While the embodiment shows two hooks 425 aligned on the same plane, it will be understood that the hooks 425 may be positioned otherwise (for example, offset from one another).

### Materials and Manufacture

In the embodiments disclosed above, some of the components (for example, the supporting element 110, the retention element 120, the back plate 130 (and their various embodiments) may be manufactured from a stiff material such as metal or hard plastic. However, other embodiments may include more flexible materials such silicone or rubber. The various components may be manufactured by extrusion, stamping, three dimensional printing, or injection molding.

Terms such as “top,” “bottom,” “front,” “rear,” “above,” “below” and the like as used in this disclosure should be understood as referring to an arbitrary frame of reference, rather than to the ordinary gravitational frame of reference. Thus, for example, an item disposed above another item may be located above or below the other item along a vertical, horizontal or diagonal direction; and an item disposed below another item may be located below or above the other item along a vertical, horizontal or diagonal direction. Some frames of references and the position of claimed structure relative to those frames of reference may be gleaned from the appended drawings. Yet, it should be understood that for some embodiments, the detection from devices disclosed herein may not be restricted to being accomplished from any particular position shown, whether the device is above, below, or on one side of the user being monitored.

Those of skill in the art would appreciate that various components and blocks may be arranged differently (e.g., arranged in a different order, or partitioned in a different way) all without departing from the scope of the subject technology. The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

Thus, the claims are not intended to be limited to the aspects shown herein, but are to be accorded the full scope consistent with the language of claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A detachable apparatus for mounting onto a support surface and supporting a device, comprising:
a backrest including a forward facing surface and a rearward facing surface;
a nano-suction cup surface coupled to the rearward facing surface of the backrest, wherein the nano-suction cup surface faces rearward from the backrest and is configured to self-adhere to the support surface;
a holder projecting forward from the forward facing surface of the backrest, configured to support the device; and
a detachable back plate configured to couple to the backrest, wherein the rearward facing surface and the nano-suction cup surface are on the back plate.

2. The apparatus of claim 1, wherein the nano-suction cup surface is integrated onto a pad.

3. The apparatus of claim 1, further comprising a rounded corner of the nano-suction cup surface, spaced from an edge of the backrest.

4. The apparatus of claim 1, wherein the holder comprises one or more arms projecting forward from the forward facing surface.

5. The apparatus of claim 1, wherein the holder comprises a basket.

6. (canceled)

7. The apparatus of claim 1, further comprising a tongue and groove system coupling the back plate to the backrest.

8. The apparatus of claim 1, further comprising a spacer feature on a forward facing side of the back plate, wherein the spacer is configured to create a gap between the rearward facing side of the backrest and the forward facing side of the back plate.

9. The apparatus of claim 1, wherein the holder comprises a tray.

10. A detachable apparatus for mounting onto a support surface and supporting a device, comprising:
a support element including a front side and a rear side;
a detachable back plate configured to couple to the rear side of the support element;
a rear surface of the back plate;
a nano-suction pad coupled to the rear surface of the back plate, configured to removably adhere to the support surface; and
a retention element coupled to the support element and configured to support the device.

11. The apparatus of claim 10, wherein the support element is a wall.

12. The apparatus of claim 10, wherein the retention element is a shelf.

13. The apparatus of claim 10, wherein the retention element is a pair of arms with ends spaced from each other.

14. The apparatus of claim 10, wherein the retention element includes a retaining wall on a distal end of the retention element.

15. The apparatus of claim 10, further comprising a tongue and groove system coupling the back plate to the support element.

16. The apparatus of claim 15, further comprising tapered slotted rails in a groove of the tongue and groove system configured to index with a tapered profile of a tongue in the tongue and groove system.

17. The apparatus of claim 10, further comprising a plurality of spacers on a front surface of the back plate, wherein the spacers are configured to create a gap between the front surface of the back plate and a rear side of the support element.

18. A detachable apparatus for mounting onto a support surface and supporting a device, comprising:
a wall including a front side and a rear side;
a detachable back plate configured to couple to the rear side of the wall;
a rear surface of the back plate;
a nano-suction pad coupled to the rear surface of the back plate, configured to removably adhere to the support surface; and
a cradle coupled to the front side of the wall, configured to support the device.

19. The apparatus of claim 18, wherein the cradle includes:
a pair of spaced arms projecting forward from the front side of the wall configured to provide an unobstructed opening for microphones or speakers of electronic devices; and
one or more ridges positioned on at least one of the arms to prevent movement of the electronic devices in the pair of spaced arms.

20. The apparatus of claim 18, further comprising a plurality of spacers on a front surface of the back plate, wherein the plurality of spacers are distributed evenly across the front surface of the back plate.
